(19) United States
(12) Patent Application Publication
(10) Pub. No.: US 2015/0303479 A1
(43) Pub. Date: Oct. 22, 2015

(54) ANODE BINDER FOR SECONDARY BATTERY, ELECTRODE FOR SECONDARY BATTERY, AND SECONDARY BATTERY COMPRISING THE SAME

(71) Applicant: SK INNOVATION CO., LTD., Seoul (KR)

(72) Inventor: Jae Yun MIN, Daejeon (KR)

(21) Appl. No.: 14/693,821

(22) Filed: Apr. 22, 2015

(30) Foreign Application Priority Data
Apr. 22, 2014 (KR) 10-2014-0047921

(51) Int. Cl. H01M 4/62; H01M 10/052

(52) U.S. Cl. CPC H01M 4/622; H01M 10/052

(57) ABSTRACT

Disclosed herein are an anode binder for secondary batteries, an electrode for secondary batteries, and a secondary battery including the same. The anode binder for secondary batteries includes an alginate, wherein the alginate is a copolymer including a D-mannuronate block and an L-guluronate block, and the alginate satisfies Equation 1:

Mₘ/M_{g}=about 0.05 to about 50 [Equation 1]

(where Mₘ is the mole number of the D-mannuronate block and M_{g} is the mole number of the L-guluronate block).

### CROSS-REFERENCE TO RELATED APPLICATION

This application claims the benefit of Korean Patent Application No. 10-2014-0047921, filed on Apr. 22, 2014 in the Korean Intellectual Property Office, the entire disclosures of which are incorporated herein by reference.

### FIELD OF THE INVENTION

The present invention relates to an anode binder for secondary batteries, an electrode for secondary batteries, and a secondary battery including the same.

### DESCRIPTION OF RELATED ART

Recently, rechargeable secondary batteries are used in wireless mobile devices, and are also used as an energy source for electric automobiles, hybrid electric automobiles, and the like, which are suggested as alternatives to existing gasoline and diesel vehicles. Applications using secondary batteries are increasingly diversifying and secondary batteries are expected to be used in various fields and articles from now on. In this regard, there is demand for research and development of high capacity secondary batteries for electric automobiles (including hybrid electric vehicles (HEVs)) and energy storage systems (ESSs).

A secondary battery is generally composed of cathodes, anodes, separators, and an electrolyte. Assembly of a typical lithium ion battery is achieved by alternately stacking the cathodes, the separators and the anodes, inserting the resulting stack into a can or a pouch having a predetermined size and shape, and then finally introducing an electrolyte into the can. Here, the electrolyte permeates between the cathode and the separator and between the anode and the separator by capillary action.

Since lithium secondary batteries (lithium ion secondary batteries) are mainly used outdoors, the lithium secondary batteries are required to have cold properties allowing operation even at a temperature as low as −30° C. However, lithium secondary batteries have had problems of abrupt reduction in reversible capacity and considerable degradation of life characteristics at a low temperature of 0° C. or less.

In addition, as an anode active material for lithium secondary batteries, various carbon and silicon-based materials allowing intercalation/deintercalation of lithium, such as synthetic graphite, natural graphite, and hard carbon, have been used. However, when such materials are used as the anode active material, a large volumetric expansion reaching 200% to 400% occurs during charge/discharge. This results in separation between the electrode active materials or between the electrode active materials and a current collector, causing malfunction of the active materials, which eventually leads to low maintenance rate of lifespan, phase transition due to volumetric expansion during an initial cycle, electrical short, large irreversible capacity due to dangling bonds, and abrupt capacity reduction in a few cycles.

A binder serves to allow particles of an anode active material to adhere to one another and to allow the anode active material to adhere to a current collector, and examples of the commonly used anode binder for lithium secondary batteries include polyamide imide (PAI), polyacrylonitrile (PAN), polyacrylic acid (PAA), and water/oil-based binders, such as polyvinylidene fluoride (PVDF)/N-methyl-2-pyrrolidone (NMP) or styrene-butadiene rubber (SBR)/carboxymethylcellulose (CMC).

Although the PVDF/NMP binder has advantages of high electrolyte wettability and excellent low-temperature output properties, the PVDF binder uses NMP, which is highly volatile and toxic, and thus has disadvantages in terms of processing costs and environment. In addition, although the SBR/CMC binder has advantages in terms of processing costs and environmental impact by using water as a solvent, the SBR/CMC binder has relatively low electrolyte wettability as compared with the PVDF binder and thus has disadvantages in terms of low-temperature characteristics. Examples of related literature on the anode binder for secondary batteries include Korean Patent Publication No. 10-2014-0008982A.

### SUMMARY OF THE INVENTION

One aspect of the present invention relates to an anode binder for secondary batteries. In one embodiment, the anode binder for secondary batteries includes alginate, wherein the alginate is a copolymer including a D-mannuronate block and an L-guluronate block, and satisfies Equation 1:

Mₘ/M_{g}=about 0.05 to about 50 [Equation 1]

(where Mₘ is the mole number of the D-mannuronate block and M_{g} is the mole number of the L-guluronate block).

In one embodiment, the alginate satisfies Equation 2:

Mₘ>M_{g} [Equation 2]

(where Mₘ is the mole number of the D-mannuronate block and M_{g} is the mole number of the L-guluronate block).

In one embodiment, the alginate has a molecular weight of about 100,000 g/mol to about 1,000,000 g/mol.

In one embodiment, a 1% aqueous solution of the alginate has a viscosity of about 10 cPs to about 25 cPs as measured at 20° C.

In one embodiment, the alginate has a mole ratio (Mₘ/M_{g}) of about 1.1 to about 10 and a weight average molecular weight of about 100,000 g/mol to about 300,000 g/mol.

In one embodiment, the alginate includes sodium alginate, magnesium alginate, or a combination thereof.

In one embodiment, the anode binder may further include at least one of styrene-butadiene rubber (SBR), polyvinyl alcohol, polyacrylic acid (PAA), carboxymethylcellulose (CMC), hydroxypropylcellulose, and diacetylcellulose.

Another aspect of the present invention relates to an electrode for secondary batteries including the anode binder for secondary batteries as set forth above. In one embodiment, the electrode for secondary batteries includes an electrode active material; and the anode binder set forth above.

In one embodiment, the electrode active material and the anode binder are included in a weight ratio of about 10:1 to about 100:1.

A further aspect of the present invention relates to a secondary battery including an anode binder for secondary batteries. In one embodiment, the secondary battery includes a cathode, an anode, and an electrolyte, wherein the anode includes the anode binder for secondary batteries set for the above.

In one embodiment, the secondary battery has a power density at room temperature of about 3,700 W/kg or more as measured by Hybrid Pulse Power Characterization (HPPC) testing, and a cold starting power output at −30° C. of about 25 W or greater as measured by Cold Cranking Test.

It is one object of the present invention to provide an anode binder for secondary batteries which may have excellent adhesion properties and exhibit excellent high-temperature power and low-temperature power characteristics.

It is another object of the present invention to provide an anode binder for secondary batteries which is economical and eco-friendly and may guarantee structural stability of an electrode material.

It is a further object of the present invention to provide an electrode for secondary batteries including the anode binder for secondary batteries.

It is yet another object of the present invention to provide a secondary battery including the electrode for secondary batteries.

The anode binder for secondary batteries according to the invention has good adhesion, thereby preventing separation between electrode active materials or between the active material and a current collector in preparation of an electrode, may control volumetric to expansion of the electrode active material occurring during charge/discharge, thereby securing structural stability of the electrode material, and is eco-friendly and economical; and a secondary battery including the anode binder may exhibit both excellent high-temperature power and low-temperature power characteristics.

### BRIEF DESCRIPTION OF DRAWINGS

FIG. 1 is a schematic view of a secondary battery according to one embodiment of the present invention.

FIG. 2 is a graph depicting low-temperature starting power output results of a secondary battery including using an anode binder for secondary batteries according to one example of the present invention.

FIG. 3 is a graph depicting low-temperature starting power output results of a secondary battery including an anode binder for secondary batteries according to another example of the present invention.

FIG. 4 is a graph depicting low-temperature starting power output results of a secondary battery including an anode binder for secondary batteries according to a further example of the present invention.

FIG. 5 is a graph depicting low-temperature starting power output results of a secondary battery including an anode binder for secondary batteries according to a comparative example of the present invention.

### DETAILED DESCRIPTION OF THE INVENTION

Detailed descriptions of functions or features known in the art will be omitted for clarity.

Further, terms to be described later are terms defined in consideration of functions of the present invention, and these may vary with the intention or practice of a user or an operator. Therefore, such terms should be defined based on the entire content disclosed herein.

As used herein, the term “secondary battery” may include a “lithium secondary battery”, and the lithium secondary battery is defined as including lithium ions, lithium polymers, and lithium ion polymer secondary batteries as well as secondary batteries using metallic lithium.

Anode Binder for Secondary Battery

One aspect of the invention relates to an anode binder for secondary batteries. The anode binder for secondary batteries according to the present invention includes alginate.

Alginate is contained in seaweeds and the like, and is used in foods due to its harmlessness to humans. In addition, alginate is suitable for a binder for secondary batteries due to its water-solubility.

In the present invention, the alginate may be a copolymer including a D-mannuronate block and an L-guluronate block.

The alginate satisfies Equation 1:

Mₘ/M_{g}=about 0.05 to about 50 [Equation 1]

(where Mₘ is the mole number of the D-mannuronate block and M_{g} is the mole number of the L-guluronate block).

In one embodiment, Mₘ/M_{g} in Equation 1 may range from about 0.2 to about 50. Within this range, the anode binder may have excellent properties in terms of endurance against volumetric change during charge/discharge, electrolyte wettability, and adhesion, while providing both excellent high-temperature and low-temperature characteristics. In addition, within this range, metal ions such as Mn²⁺ may be well captured, whereby negative reactions at an anode may be suppressed when using a cathode active material releasing the metal ions, such as lithium-manganese oxide (LiMnO₂, LMO), thereby providing enhanced high-temperature characteristics.

If the mole number ratio (Mₘ/M_{g}) of the D-mannuronate and the L-guluronate is less than 0.05, this may cause deterioration in electrolyte wettability and degradation of low-temperature power and high-temperature power characteristics of the secondary battery, whereas, if the mole number ratio is higher than 50, rigidity of the anode binder increases too much to withstand volumetric change during charge/discharge, which may also cause degradation of low-temperature power and high-temperature power characteristics.

In another embodiment, the mole number ratio may range from about 1 to about 20. In a further embodiment, the mole number ratio may range from about 1.5 to about 15. For example, the mole number ratio may be about 0.05, 0.1, 0.15, 0.2, 0.3, 0.5, 0.6, 0.7, 0.8, 0.9, 1, 1.5, 2, 2.5, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

In one embodiment, the alginate satisfies Equation 2:

Mₘ>M_{g} [Equation 2]

(where Mₘ is the mole number of the D-mannuronate block and M_{g} is the mole number of the L-guluronate block).

As in Equation 2, when the mole number (Mₘ) of the D-mannuronate block is higher than that (M_{g}) of the L-guluronate block, the secondary battery may exhibit both excellent low-temperature power and high-temperature power characteristics, whereas, when Mₘ is lower than M_{g}, rigidity of the anode binder increases too much to withstand volumetric change during charge/discharge, which may cause degradation of low-temperature power and high-temperature power characteristics.

In one embodiment, the alginate may have a weight average molecular weight of about 100,000 g/mol to about 1,000,000 g/mol. Within this range, the anode binder may exhibit excellent adhesion in application thereof; improve battery capacity maintenance; maintain electrical resistance in the anode at a proper level; and allows the secondary battery to exhibit excellent low-temperature power output characteristics. In one embodiment, the alginate may have a weight average molecular weight of about 100,000 g/mol to about 300,000 g/mol. In another embodiment, the alginate may have a weight average molecular weight of about 110,000 g/mol to about 200,000 g/mol.

In one embodiment, a 1% aqueous solution of the alginate may have a viscosity of about 10 cPs to about 25 cPs as measured at 20° C. using a viscometer. Within this range, the anode binder may exhibit good adhesion and be easily applied to an anode current collector in preparation of an anode for secondary batteries, and allows the secondary battery to exhibit excellent low-temperature power and high-temperature power characteristics. For example, a 1% aqueous solution of the alginate may have a viscosity of about 11 cPs to about 20 cPs. For example, a 1% aqueous solution of the alginate may have a viscosity of about 10 cPs, 11 cPs, 12 cPs, 13 cPs, 14 cPs, 15 cPs, 16 cPs, 17 cPs, 18 cPs, 19 cPs, 20 cPs, 21 cPs, 22 cPs, 23 cPs, 24 cPs, or 25 cPs.

In one embodiment, the alginate may include at least one of sodium alginate and magnesium alginate. When this type of alginate is used, the secondary battery may have excellent properties in terms of structural stability and adhesion while exhibiting good low-temperature power and high-temperature power output characteristics and cycle characteristics.

In one embodiment, the alginate may be sodium alginate. In this case, it is possible to easily control contraction/expansion of active materials.

In another embodiment, the alginate may be magnesium alginate. Thus, substitution of Li⁺ for Na⁺ may be prevented by virtue of high structural stability, whereby the secondary battery may exhibit excellent high-temperature characteristics and cycle characteristics.

In one embodiment, the alginate may have a mole ratio (Mₘ/M_{g}) of about 1.1 to about 10 and a weight average molecular weight of about 100,000 g/mol to about 300,000 g/mol. In this case, the anode binder may exhibit good adhesion and be easily applied to an anode current collector, while allowing the secondary battery to exhibit excellent low-temperature power and high-temperature power output characteristics.

In another embodiment, the anode binder for secondary batteries may further include at least one adhesion enhancing agent selected from among styrene-butadiene rubber (SBR), polyvinyl alcohol, polyacrylic acid (PAA), carboxymethylcellulose (CMC), hydroxypropylcellulose, and diacetylcellulose.

In one embodiment, the anode binder for secondary batteries may include, as the adhesion enhancing agent, styrene-butadiene rubber (SBR) and carboxymethylcellulose (CMC) in a weight ratio of about 1:1. When these adhesion enhancing agents are used, the ratio of the anode active material for a given volume may be increased by virtue of high binding capability, thereby providing increased capacity.

The adhesion enhancing agent may have a molecular weight of about 100,000 g/mol to about 1,000,000 g/mol. Within this range, the anode bonder may exhibit excellent adhesion in application thereof, improve battery capacity maintenance, maintain electrical resistance in the anode at a proper level, and allow the secondary battery to exhibit excellent low-temperature power output characteristics. For example, the adhesion enhancing agent may have a molecular weight of about 100,000 g/mol to about 300,000 g/mol.

In one embodiment, the adhesion enhancing agent may be included in an amount of about 10 parts by weight to about 80 parts by weight based on 100 parts by weight of the alginate. Within this range, the anode bonder may exhibit further improved adhesion in application thereof, improve battery capacity maintenance, maintain electrical resistance in the anode at a proper level, and allow the secondary battery to exhibit further enhanced low-temperature power output characteristics. For example, the adhesion enhancing agent may be included in an amount of about 30 to about 70 parts by weight. For example, the adhesion enhancing agent may be included in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 parts by weight.

Electrode for Secondary Battery

Another aspect of the present invention relates to an electrode for secondary batteries including the anode binder for secondary batteries as set forth above. In one embodiment, the electrode for secondary batteries may include an electrode active material; and the anode binder for secondary batteries. Further, in one embodiment of the invention, the electrode for secondary batteries may be an anode.

In one embodiment, the electrode for secondary batteries may include a current collector; an electrode active material; and the anode binder for secondary batteries.

As the current collector, any metal may be used so long as the metal has electrical conductivity. In one embodiment, the current collector may be an aluminum (Al) foil or a copper (Cu) foil.

The electrode active material may include a material allowing reversible intercalation/deintercalation of lithium ions. In one embodiment, the electrode active material may be metallic lithium, an alloy of metallic lithium, a material capable of doping/dedoping lithium, or a transition metal oxide. More specifically, the anode active material may include metallic lithium or a lithium alloy, coke, synthetic graphite, natural graphite, a carbonized organic polymer compound, carbon fiber, Si, SiOx, Sn, SnO₂, and the like.

In another embodiment, the electrode for secondary batteries may further include a conductive material. More specifically, the conductive material may include metallic powder or fiber of copper, nickel, aluminum, and silver; and a conductive polymer material such as polyphenylene derivatives, and the like. These materials may be used alone or in combination thereof.

The anode for secondary batteries may be prepared by any typical method. For example, the electrode active material and the anode binder are mixed with a solvent to prepare an electrode slurry, followed by applying the electrode slurry to the anode current collector and drying, thereby preparing the anode for secondary batteries.

As the solvent, water may be used. Since water is used as the solvent rather than using an organic solvent, such as NMP, there is an advantage in terms of processing costs and environmental impact.

In one embodiment, in the entire slurry including the electrode active material, the anode binder, and the solvent, the alginate may be present in an amount of about 0.01% by weight (wt %) to about 10 wt % in terms of solid content. Within this range, it is possible to provide excellent workability and formability and allow the secondary battery to exhibit excellent properties in terms of structural stability and adhesion, and to have enhanced low-temperature and high-temperature power characteristics and cycle characteristics. For example, the alginate may be present in an amount of about 0.01 wt %, 0.02 wt %, 0.03 wt %, 0.04 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, or 10 wt %.

In one embodiment, the electrode active material and the anode binder may be included in a weight ratio of about 10:1 to about 100:1 in terms of solid content. Within this range, the percentage of the anode active material for a given volume may be increased by virtue of high binding capability, thereby allowing increased capacity of the secondary battery. For example, the electrode active material and the anode binder may be included in a weight ratio of about 15:1 to about 80:1.

Secondary Battery

A further aspect of the present invention relates to a secondary battery including the anode for secondary batteries.

In one embodiment, the battery includes a cathode; an anode; and an electrolyte, wherein the anode may include the electrode for secondary batteries as set forth above.

In one embodiment, the battery includes a cathode; an anode; and an electrolyte, wherein the anode may include the anode binder for secondary batteries as set forth above.

FIG. 1 is a schematic view of a secondary battery according to one embodiment of the present invention. Referring to FIG. 1, in this embodiment of the invention, the secondary battery 100 may include a cathode 10, an anode 20, a separator 30 interposed between the cathode 10 and the anode 20, and an electrolyte (not shown).

In one embodiment, the cathode 10 may include a cathode active material and a cathode binder. In another embodiment, the cathode 10 may include a cathode active material, a conductive material, and a cathode binder.

The cathode current collector may include a material obtained by surface treatment of copper or stainless steel with carbon, nickel, or titanium; or carbon fibers or plastic fiber meshes coated with a conductive metal, as well as stainless steel, aluminum, iron, copper, titanium, carbon, and conductive resins.

The cathode active material may be a typical cathode active material. For example, the cathode active material may be LiCoO₂, LiNi₍ᵢ₋ₓ₎MₓO₂ (where x ranges from 0.95 to 1, and M is Al, Co, Ni, Mn, or Fe), or LiMn₂O₄.

The conductive material may include carbon-based materials such as natural graphite, synthetic graphite, carbon black, acetylene black, ketchen black, and carbon fiber; metallic powder or fiber of copper, nickel, aluminum, silver, and the like; and a conductive polymer material such as polyphenylene derivatives. These materials may be used alone or in combination thereof.

The cathode binder may include vinylidenefluoride/hexafluoropropylene copolymer (VDF/HFP), polyvinylidene fluoride (PVDF), polyacrylonitrile (PAN), polymethylmethacrylate (PMMA), and polytetrafluoroethylene (PTFE). These may be used alone or in combination thereof.

As a solvent for the cathode binder, water and an organic solvent may be used, without being limited thereto. The organic solvent may include n-methylpyrrolidone (NMP), dimethylformamide (DMF), acetone, and dimethylacetamide, without being limited thereto.

Referring to FIG. 1, the cathode 10 may be prepared by a process in which the cathode active material, the conductive material, and the cathode binder are mixed with the solvent to prepare cathode slurry, followed by applying the slurry to at least one surface of the cathode current collector 12 and drying, thereby forming a cathode active material coating layer 14.

The electrolyte may be a typical electrolyte. For example, the electrolyte may be obtained by dissolving and dissociating a salt having a structure of A⁺B⁻, wherein A⁺ includes alkali metal cations such as Li⁺, Na⁺, K⁺, and combinations thereof, and B⁻ includes anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)²⁻, C(CF₂SO₂)³⁻, and combinations thereof, in an organic solvent including propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), γ-butyrolactone, or mixtures thereof.

The separator 30 may be a typical separator. For example, the separator may include olefin polymers such as chemically resistant and hydrophobic polyolefins; and a sheet or non-woven fabric made of glass fiber or polyethylene.

As described above, the anode 20 may be prepared by any typical method. For example, the anode may be prepared by a process in which the electrode active material and the anode binder are mixed with the solvent to prepare an anode slurry, followed by applying the slurry to at least one surface of the anode current collector 22 and drying, thereby forming an anode active material coating layer 24.

In one embodiment, the secondary battery may have a power density at room temperature of about 3,700 W/kg or more as measured by HPPC testing. Specifically, the secondary battery may have a power density at room temperature of about 3,700 W/kg to about 6,000 W/kg.

In one embodiment, the secondary battery may have a cold starting power output at −30° C. of about 25 W or greater as measured by Cold Cranking Test. Specifically, the secondary battery may have a cold starting power output at −30° C. of about 25 W to about 85 W.

Here, the HPPC (hybrid pulse power characterization) test is an internationally standardized method which was established by the United States Department of Energy (DOE) and defines conditions for power measurement (See FreedomCar battery test manual for power-assist hybrid electric vehicles, DOE/ID-11069, 2003).

In addition, the Cold Cranking Test was established to define measurement conditions for cold starting power output at −30° C. by Verband der Automobilindustrie (VDA) (See TEST SPECIFICATION FOR LI-ION BATTERY SYSTEMS IN HYBRID ELECTRIC VEHICLES RELEASE 1.0 (Mar. 5, 2007)).

Next, the present invention will be described in more detail with reference to some examples. It should be understood that these examples are provided for illustration only and are not to be construed in any way as limiting the invention. In addition, descriptions of details apparent to those skilled in the art will be omitted for clarity.

### EXAMPLES AND COMPARATIVE EXAMPLES

(a) Cathode: A dispersion containing PVDF, NMP, and acetylene black was coated onto a carbon fiber mesh sheet with copper coated on both sides, thereby preparing a cathode current collector. Cathode slurry obtained by mixing a cathode active material including LiMn₂O₄ (LMO) and LiNi_{1/3}Co_{1/3}Mn_{1/3}O₂ (NCM) in a weight ratio of 1:1, a conductive material (carbon black), and a cathode binder (PVDF) with a solvent (acetone) was applied to both surfaces of the cathode current collector, followed by drying and rolling using a typical method to form a cathode active material coating layer, thereby preparing a cathode.

(b) Electrolyte: An electrolyte was prepared by dissolving LiPF₆ into a mixed solution of ethylcarbonate (EC)/ethylmethylcarbonate (EMC)/diethylcarbonate (DEC)/propylene carbonate (PC) at a concentration of 1 M.

(c) Separator: a polyethylene separator was prepared.

(d1) Anode: As an anode binder, sodium alginate having a molecular weight of 120,000 g/mol and a viscosity in 1% aqueous solution of 15 cPs as measured at 20° C. and including a D-mannuronate block and an L-guluronate block in a mole ratio (mole number of D-mannuronate block (Mₘ)/mole number of L-guluronate block (M_{g})) Mₘ/M_{g}=0.1 was mixed with an electrode active material (anode active material, synthetic graphite) and a solvent (water) to prepare an anode slurry, followed by applying the slurry to an upper surface of an anode current collector (copper foil) to a dry coating thickness of 100 μm to form an active material coating layer, thereby preparing an anode. Here, the active material and the anode binder were included in the anode in a weight ratio of 19:1.

(d2) An anode was prepared in the same manner as in d1 except that a D-mannuronate block and an L-guluronate block were included in a mole ratio Mₘ/M_{g}=0.25.

(d3) An anode was prepared in the same manner as in d1 except that a D-mannuronate block and an L-guluronate block were included in a mole ratio Mₘ/M_{g}=1.5.

(d4) An anode was prepared in the same manner as in d1 except that a D-mannuronate block and an L-guluronate block were included in a mole ratio Mₘ/M_{g}=4.

(d5) An anode was prepared in the same manner as in d1 except that a D-mannuronate block and an L-guluronate block were included in a mole ratio Mₘ/M_{g}=10.

(d6) An anode was prepared in the same manner as in d1 except that a D-mannuronate block and an L-guluronate block were included in a mole ratio Mₘ/M_{g}=0.02.

(d7) An anode was prepared in the same manner as in d1 except that a D-mannuronate block and an L-guluronate block were included in a mole ratio Mₘ/M_{g}=60.

### Example 1

The cathode (a), the anode (d1), and the separator (c) were laminated in a plastic battery case, followed by introducing the electrolyte (b) and sealing the case, thereby fabricating a lithium secondary battery.

### Example 2

A 6 Ah lithium secondary battery was fabricated in the same manner as in Example 1 except that the anode (d2) was used instead of the anode (d1).

### Example 3

A 6 Ah lithium secondary battery was fabricated in the same manner as in Example 1 except that the anode (d3) was used instead of the anode (d1).

### Example 4

A 6 Ah lithium secondary battery was fabricated in the same manner as in Example 1 except that the anode (d4) was used instead of the anode (d1).

### Example 5

A 6 Ah lithium secondary battery was fabricated in the same manner as in Example 1 except that the anode (d5) was used instead of the anode (d1).

### Comparative Example 1

A 6 Ah lithium secondary battery was fabricated in the same manner as in Example 1 except that the anode (d6) was used instead of the anode (d1).

### Comparative Example 2

A 6 Ah lithium secondary battery was fabricated in the same manner as in Example 1 except that the anode (d7) was used instead of the anode (d1).

### Comparative Example 3

A 6 Ah lithium secondary battery was fabricated in the same manner as in Example 1 except that, as the anode binder, styrene-butadiene rubber (SBR) and carboxymethylcellulose (CMC) were used in a weight ratio of 1:1.

### Experimental Example

For each of the 6 Ah-rated lithium secondary batteries fabricated in Examples 1 to 5 and Comparative Examples 1 to 3, battery performance was evaluated as follows.

(1) Power density at room temperature (W/kg): For each of the 6 Ah-rated lithium secondary batteries fabricated in Examples 1 to 5 and Comparative Examples 1 to 3, power density at room temperature was measured in accordance with the hybrid pulse power characterization (HPPC) test method (See FreedomCar battery test manual for power-assist hybrid electric vehicles, DOE/ID-11069, 2003). Specifically, with state of charge (SOC) adjusted to 50%, voltage variance upon discharging in a 30 A constant current mode (CC) at 25° C. was measured to find DC impedance, and a value of discharge pulse power capability upon application of a lower limit voltage of 2.5 V was measured, followed by dividing the value by the weight of cells, thereby calculating power density at room temperature. Results are shown in Table 1.

(2) Cold-starting power output at −30° C. (W): For each of the 6 Ah-rated lithium secondary batteries fabricated in Examples 1 to 5 and Comparative Examples 1 to 3, cold-starting power output at −30° C. was measured in accordance with Cold Cranking Test established by Verband der Automobilindustrie (VDA) (See paragraph 11 of TEST SPECIFICATION FOR LI-ION BATTERY SYSTEMS IN HYBRID ELECTRIC

VEHICLES RELEASE 1.0 (Mar. 5, 2007)). Specifically, for each of the 6 Ah-rated lithium secondary batteries fabricated in Examples 1 to 5 and Comparative Examples 1 to 3, 5 seconds discharge/10 seconds rest was applied three times at a constant current-voltage of 200 A-2 V at −30° C., followed by measuring the value of a current shortly before the 3^{rd} rest and multiplying the value by 2 V. Results are shown in Table 1.

TABLE 1

| | Examples | | | | | Comparative Examples | | |
|---|---|---|---|---|---|---|---|---|
| | 1 | 2 | 3 | 4 | 5 | 1 | 2 | 3 |
| Power density at room | 3,678 | 3,729 | 4,060 | 4,900 | 4,850 | 3,510 | 3,012 | 3,523 |
| temperature (W/kg) | | | | | | | | |
| Cold-starting power | 25 | 26 | 54 | 74 | 72 | 20 | 10 | 22 |
| output at | | | | | | | | |
| −30° C. (W) | | | | | | | | |

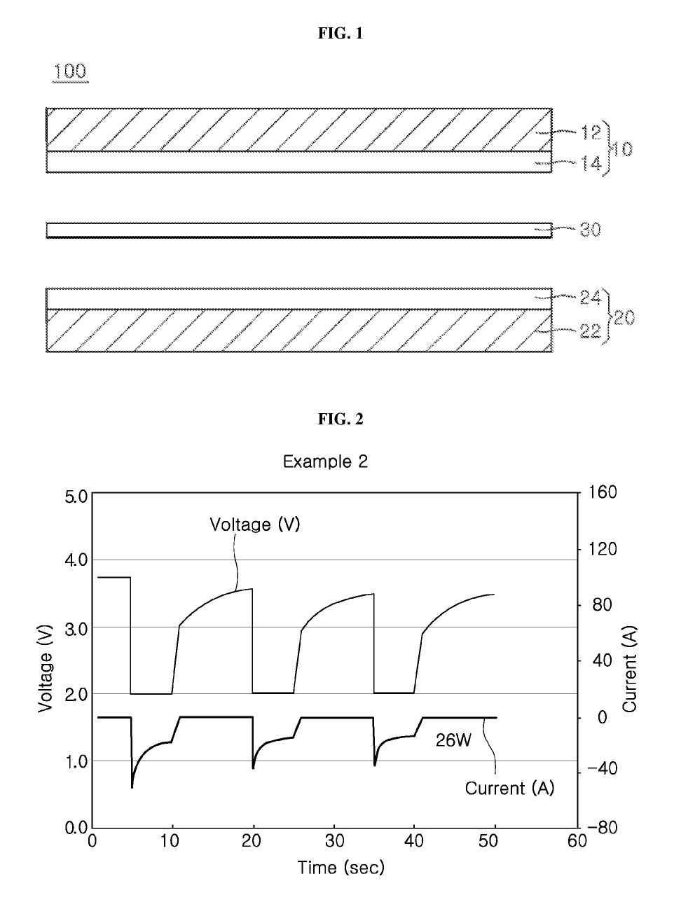

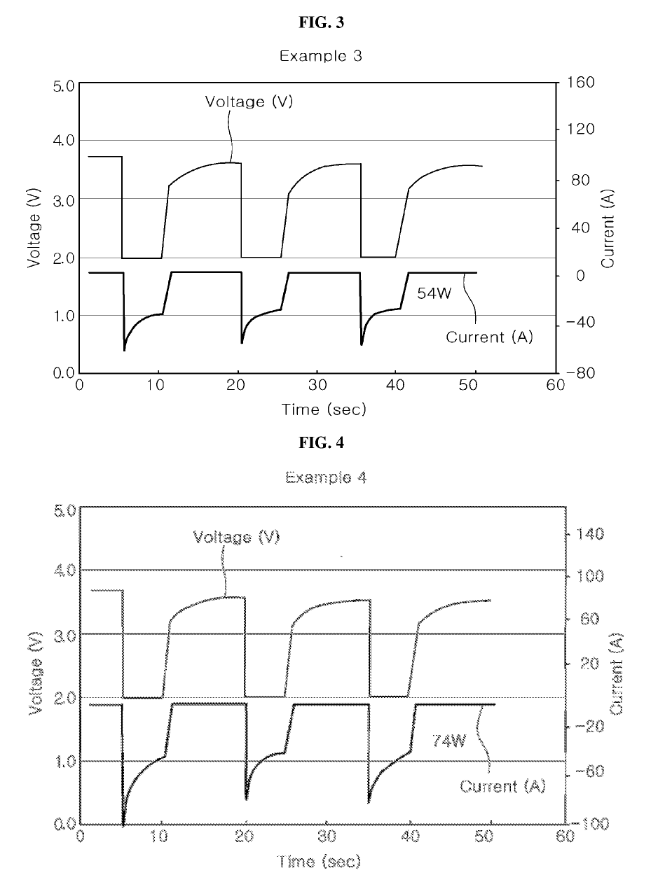

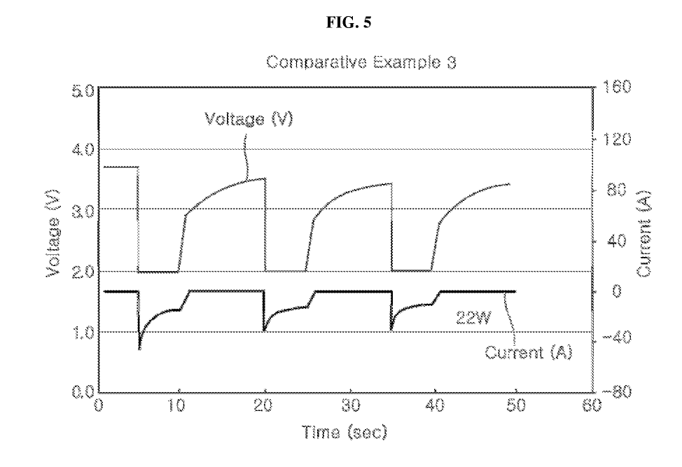

FIG. 2 is a graph depicting low-temperature starting power output results of a secondary battery including an anode binder for secondary batteries according to Example 2 of the present invention; FIG. 3 is a graph depicting low-temperature starting power output results of a secondary battery including an anode binder for secondary batteries according to Example 3 of the present invention; FIG. 4 is a graph depicting low-temperature starting power output results of a secondary battery including an anode binder for secondary batteries according to Example 4 of the present invention; and FIG. 5 is a graph depicting low-temperature starting power output results of a secondary battery including an anode binder for secondary batteries according to Comparative Example 3.

Referring to Table 1 and FIGS. 2 to 5, the secondary batteries of Examples 1 to 5 which employed alginate including the D-mannuronate block and the L-guluronate block in a mole ratio (mole number of D-mannuronate block (Mₘ)/mole number of L-guluronate block (M_{g})) Mₘ/M_{g} as defined herein exhibited relatively high power density at room temperature and cold-starting power output at −30° C. as compared with those of Comparative Examples 1 to 3 which did not satisfy the mole ratio (Mₘ/M_{g}) as defined herein, or did not include the alginate. From this result, it may be seen that, when the anode binder for secondary batteries according to the present invention is used, the resultant secondary battery has excellent properties in terms of structural stability and adhesion, while exhibiting enhanced low-temperature poweroutput characteristics.

What is claimed is:

1. An anode binder for secondary batteries, comprising an alginate, wherein the alginate is a copolymer including a D-mannuronate block and an L-guluronate block, and satisfies Equation 1:
Mₘ/M_{g}=about 0.05 to about 50 [Equation 1]
(where Mₘ is the mole number of the D-mannuronate block and M_{g} is the mole number of the L-guluronate block).

2. The anode binder for secondary batteries according to claim 1, wherein the alginate satisfies Equation 2:
Mₘ>M_{g} [Equation 2]
(where Mₘ is the mole number of the D-mannuronate block and M_{g} is the mole number of the L-guluronate block).

3. The anode binder for secondary batteries according to claim 1, wherein the alginate has a molecular weight of about 100,000 g/mol to about 1,000,000 g/mol.

4. The anode binder for secondary batteries according to claim 1, wherein a 1% aqueous solution of the alginate has a viscosity of about 10 cPs to about 25 cPs as measured at 20° C.

5. The anode binder for secondary batteries according to claim 1, wherein the alginate has a mole ratio (Mₘ/M_{g}) of about 1.1 to about 10 and a weight average molecular weight of about 100,000 g/mol to about 300,000 g/mol.

6. The anode binder for secondary batteries according to claim 1, wherein the alginate comprises sodium alginate, magnesium alginate, or a combination thereof.

7. The anode binder for secondary batteries according to claim 1, further comprising: at least one of styrene-butadiene rubber (SBR), polyvinyl alcohol, polyacrylic acid (PAA), carboxymethylcellulose (CMC), hydroxypropylcellulose, and diacetylcellulose.

8. A secondary battery, comprising:
a cathode;
an anode; and
an electrolyte,
wherein the anode comprises the anode binder for secondary batteries according claim 1 to claim 7.

9. The secondary battery according to claim 8, wherein the secondary battery has a power density at room temperature of about 3,700 W/kg or more as measured by HPPC discharge power measurement method, and a cold starting power output at −30° C. of about 25 W or greater as measured by Cold Cranking Test.
